(19) United States
(12) Patent Application Publication
(10) Pub. No.: US 2023/0354977 A1
(43) Pub. Date: Nov. 9, 2023

(54) TRANSPORTABLE DISPLAY SYSTEMS AND METHODS

(71) Applicant: MetaSill, Inc.,, Milpitas, CA (US)

(72) Inventor: Yi Lin, Milpitas, CA (US)

(73) Assignee: MetaSill, Inc.,, Milpitas, CA (US)

(21) Appl. No.: 18/312,792

(22) Filed: May 5, 2023

Related U.S. Application Data
(60) Provisional application No. 63/339,299, filed on May 6, 2022.
(60) Provisional application No. 63/339,634, filed on May 9, 2022.

(51) Int. Cl. A45C 15/00; G06F 3/14; A45C 5/03; A45C 5/14

(52) U.S. Cl. CPC A45C 15/00; G06F 3/14; A45C 5/03; A45C 5/14

(57) ABSTRACT

The present invention is directed to transportable display systems and methods. In an exemplary embodiment, a display system comprises a suitcase, a support member configured to detachably couple to the suitcase, and a display configured to detachably couple to the suitcase via the support member. The display is further configured to display a media file, the media file being linked to a non-fungible token (NFT) stored on a blockchain. The suitcase is configured to accommodate the support member and the display for transportation and protection. There are other embodiments as well.

### CROSS-REFERENCES TO RELATED APPLICATIONS

The present application claims priority to U.S. Provisional Application No. 63/339,299, entitled “Transportable Display System and Method”, filed May 6, 2022, and U.S. Provisional Application No. 63/339,634, entitled “Connected Display Systems and Methods with Content Authentication”, filed May 9, 2022, which are commonly owned and incorporated by reference herein for all purposes.

### BACKGROUND OF THE INVENTION

The present invention relates to the field of digital asset display and management systems and methods, specifically to transportable display systems and methods configured to showcase and interact with non-fungible tokens (NFTs).

Non-fungible tokens (NFTs) have gained significant popularity in recent years as a unique and secure method of representing ownership and provenance of digital assets. NFTs are digital tokens that are cryptographically linked to a specific digital asset, such as art, collectibles, music, videos, and even virtual real estate. Unlike fungible tokens such as cryptocurrencies, each NFT is unique and cannot be exchanged on a one-to-one basis with another NFT. This uniqueness has created a thriving market for digital art, collectibles, and other forms of digital assets, transforming the way people buy, sell, and interact with these assets.

As the market for NFTs continues to grow, so does the demand for innovative methods to display, showcase, and interact with these digital assets. Traditional display systems, such as computer monitors, digital photo frames, and mobile devices, have limitations in terms of portability, customization, and interactivity. Moreover, these systems are not specifically designed to handle the unique characteristics and requirements of NFTs, such as verifying ownership, updating provenance, and facilitating secure transactions.

Several attempts have been made to develop display systems that cater to NFTs, but they have been inadequate, for reasons described in further detail below. Hence, there is a need for more robust and scalable solutions for implementing transportable display systems and methods designed for NFTs.

### BRIEF SUMMARY OF THE INVENTION

The present invention is directed to transportable display systems and methods. In an exemplary embodiment, a display system comprises a suitcase, a support member configured to detachably couple to the suitcase, and a display configured to detachably couple to the suitcase via the support member. The display is further configured to display a media file, the media file being linked to a non-fungible token (NFT) stored on a blockchain. The suitcase is configured to accommodate the support member and the display for transportation and protection. There are other embodiments as well.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a display system. The display system includes a suitcase, which may include a suitcase body and a wheel coupled to a first end of the suitcase body. The system also includes a support member configured to detachably couple to the suitcase. The system also includes a display configured to detachably couple to the suitcase via the support member, the display being further configured to display a media file, the media file being linked to a non-fungible token (NFT) stored on a blockchain. The suitcase body is configured to accommodate the support member and the display, the suitcase body further may include a foam member configured to protect the support member and the display. Other embodiments of this aspect include corresponding computer systems, apparatus, and computer programs recorded on one or more computer storage devices, each configured to perform the actions of the methods.

Implementations may include one or more of the following features. The display system may include a cover configured to detachably couple to a second end of the suitcase body, the suitcase body being configured to accommodate the cover. The wheel may include a locking mechanism configured to control the wheel movement. The suitcase further may include a power module coupled to the suitcase body, the power module is configured to provide electrical power for the display. The system may include a power cord configured to connect the display to the power module. The power cord is configured inside the support member. The media file may include a sound clip, a picture, and/or a video clip. The display may include a touch screen. The display further may include: a playback interface configured to provide playback of the media file; a communication interface configured to establish a connection to a first network entity; a memory configured to store the media file; a processor configured to: transmit a unique identifier to the first network entity via the communication interface; receive an authorization message from the first network entity for displaying the media file; receive the media file over the communication interface; store the media file in the memory; and starting playback of the media file. The display may be configured to connect to a mobile device via the communication interface. A height of the support member is adjustable. The media file may include a sound clip, a picture, and/or a video clip. Implementations of the described techniques may include hardware, a method or process, or computer software on a computer-accessible medium.

One general aspect includes a display system. The display system includes a suitcase, which may include a suitcase body and a wheel coupled to a first end of the suitcase body. The system also includes a support member configured to detachably couple to the suitcase. The system also includes a display configured to detachably couple to the suitcase via the support member, the display being further configured to display a media file, the display may include: a playback interface configured to provide playback of the media file; a communication interface configured to establish a connection to a first network entity; a processor configured to receive the media file over the communication interface in response to an authorization message for displaying the media file from the first network entity, the media file being linked to a non-fungible token (NFT) on a blockchain; and a memory configured to store the media file. The suitcase body is configured to accommodate the support member and the display. Other embodiments of this aspect include corresponding computer systems, apparatus, and computer programs recorded on one or more computer storage devices, each configured to perform the actions of the methods.

Implementations may include one or more of the following features. The communication interface be further configured to connect the display to a mobile device. The display is configured to display the media file at a 1:1 scale. The display system may include a cover configured to couple to the support member. The display is characterized by a resolution greater than 1920×1080. Implementations of the described techniques may include hardware, a method or process, or computer software on a computer-accessible medium.

One general aspect includes a display system. The display system includes a suitcase, which may include a suitcase body, a wheel coupled to a first end of the suitcase body, and a handle coupled to a second end of the suitcase body. The system also includes a support member configured to detachably couple to the suitcase. The system also includes a display configured to detachably couple to the suitcase via the support member, the display being further configured to display a media file, the media file being linked to a non-fungible token (NFT) associated with an authorized owner, an identification of the authorized owner being stored on a blockchain. The suitcase body is configured to accommodate the support member and the display. Other embodiments of this aspect include corresponding computer systems, apparatus, and computer programs recorded on one or more computer storage devices, each configured to perform the actions of the methods.

Implementations may include one or more of the following features. The suitcase body further may include a foam member positioned inside the suitcase body. The display system may include a cover configured to detachably couple to the second end of the suitcase body, the suitcase body being configured to accommodate the cover. Implementations of the described techniques may include hardware, a method or process, or computer software on a computer-accessible medium.

It is to be appreciated that embodiments of the present invention provide many advantages, which can be leveraged for various display purposes including, without limitation, presentations, advertisements, exhibitions, and/or the like. Among other things, the system is designed for easy transportation—with all components stored in a suitcase part—facilitating smooth and effortless transitions between locations. This makes it convenient for users to showcase their NFT-linked media files in various locations. The suitcase body includes a foam member that offers protection for the display and support member during transport, reducing the risk of damage. The wheel at the first end of the suitcase body features a locking mechanism, ensuring that the display remains stationary and stable during use. The height of the support member is adjustable, allowing users to set the display at the most suitable and comfortable viewing height.

Additionally, the assembly mechanism enables rapid and straightforward assembly and disassembly of the system, thereby saving time and eliminating the need for additional assistance. Embodiments of the present invention offer a high degree of versatility, facilitating its use across a range of settings and display requirements. The power cord connecting the display to the power module may be configured inside the support member, providing a clean and uncluttered appearance. In various implementations, the display system is capable of showcasing various media file types, such as sound clips, pictures, and video clips, offering flexibility in the content displayed. The touchscreen display enables users to interact with the content easily and intuitively.

The system can be adapted to accommodate different display parts and setups, allowing users to tailor it to their specific needs. The ease of use and transportation further broadens the potential applications for the system across diverse scenarios, including but not limited to, presentation stands, show stands, NFT display stands, and/or the like. The display includes a playback interface, communication interface, memory, and processor, allowing users to connect to a network entity, receive authorization to display the media file, store the media file, and initiate playback. The display system can connect to a mobile device, enabling users to control the display or access additional features through their smartphones or tablets. There are other benefits as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a side view of a transportable display system according to embodiments of the present invention.

FIG. 2 is a front view of a transportable display system according to embodiments of the present invention.

FIGS. 3A-3B are side views of a transportable display system according to embodiments of the present invention.

FIG. 4 is a simplified block diagram illustrating a display of a transportable display system according to embodiments of the present invention.

FIG. 5 is a simplified block diagram illustrating a multi-display system of a transportable display system according to embodiments of the present invention.

### DETAILED DESCRIPTION OF THE INVENTION

The present invention is directed to transportable display systems and methods. In an exemplary embodiment, a display system comprises a suitcase, a support member configured to detachably couple to the suitcase, and a display configured to detachably couple to the suitcase via the support member. The display is further configured to display a media file, the media file being linked to a non-fungible token (NFT) stored on a blockchain. The suitcase is configured to accommodate the support member and the display for transportation and protection. There are other embodiments as well.

Several attempts have been made to develop display systems that cater to NFTs, but these solutions are often either limited in functionality or not portable. For example, digital galleries and virtual reality environments allow for the showcasing of NFTs, but they are restricted to online spaces and require specific hardware and software configurations. Physical display solutions, such as digital frames, often lack the necessary features and security measures needed for NFT transactions and interactions.

Therefore, a general aspect of the present invention provides transportable display systems specifically designed for NFTs that address the limitations of existing solutions. Embodiments of the present invention are capable of showcasing NFTs in various environments (e.g., at home, in galleries, at public exhibitions, and/or the like) and incorporate features that facilitate secure and seamless transactions and interactions with these digital assets.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

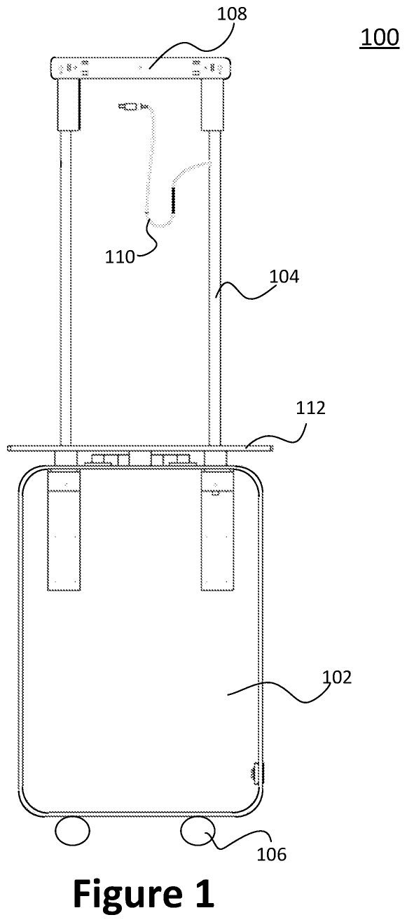

FIG. 1 is a side view of a transportable display system 100 according to embodiments of the present invention. This diagram is merely an example, which should not unduly limit the scope of the claims. One of ordinary skill in the art would recognize many variations, alternatives, and modifications.

As shown, the transportable display system 100 includes a suitcase, which may include a suitcase body 102 and a wheel 106 coupled to a first end of suitcase body 102. In some cases, the suitcase includes one or more wheels attached to the first end of the suitcase body 102, the one or more wheels allow users to move the suitcase effortlessly. The one or more wheels 106 may include, without limitation, one or more spinner wheels, one or more in-line skate wheels, and/or the like. In some embodiments, wheel 106 comprises a locking mechanism configured to control the wheel movement. For instance, wheel 106 includes a locking caster, which may include, without limitation, at least one of a side lock brake, a tech lock brake, a total lock brake, and/or the like. The locking caster can control the wheel rotation and/or swivel movement and prevent unintended movement when engaged. For instance, by engaging the locking mechanism, transportable display system 100 can remain stationary and serve as a presentation platform for displaying one or more media files in various settings.

Suitcase body 102 is configured to accommodate one or more items for storage and transportation. In various implementations, transportable display system 100 includes a support member 104 configured to detachably couple to the suitcase. Support member 104 may include one or more mounting elements (not shown) that are configured for mechanical connection with other components (e.g., suitcase body 102). Transportable display system 100 can also include a power cord 110 configured for electrical connection among components. Power cord 110 may be positioned within support member 104 for a clean and organized visual appearance. According to an embodiment, a dedicated channel or groove can be integrated within the support member 104, allowing the power cord 110 to run through it. This not only conceals the power cord but also provides a secure and stable placement. Support member 104 may be configured as a modular assembly with multiple interlocking pieces. The power cord 110 can be placed within the hollow sections of these interlocking pieces, which, when assembled, conceal the power cord entirely. In some implementations, power cord 110 can be enclosed within a flexible conduit integrated into the support member 104. This configuration protects the power cord from external damage and keeps it hidden from view while maintaining the flexibility of the support member. Additionally, support member 104 may include built-in cable management features, such as clips, hooks, or channels that secure and organize the power cord 110 within the support member. This approach ensures that the power cord remains concealed while also preventing it from tangling or getting caught during transportation or use.

In various implementations, a height of support member 104 is adjustable (e.g., manually or automatically). For example, support member 104 may include a plurality of nested sections (not shown) that can slide in and out of each other for height adjustment. A user can unlock the sections using a locking mechanism (e.g., a twist lock, clamp lock, and/or the like) to adjust support member 104 to a desired height. Once the desired height is reached, the locking mechanism can be re-engaged to secure support member 104 in place. In some embodiments, support member 104 may include an automatic height adjustment mechanism. For instance, a motor element or an actuator element may be used to control the extension and retraction of the plurality of nested sections, allowing users to adjust the height using a remote control or an integrated interface.

Transportable display system 100 may also include a handle 108 that is used to carry the suitcase. Handle 108 may include a telescoping handle coupled to a second end of suitcase body 102 and can be configured between a retracted position and an extended position for easy carrying. When handle 108 is in a retracted position, handle 108 may be in direct contact with suitcase body 102 and substantially flush with the second end of suitcase body 102. When handle 108 is in an extended position, it extends away from the second end of suitcase body 102.

In various implementations, transportable display system 100 further includes a cover 112 configured to detachably couple to suitcase body 102. For example, cover 112 includes a substantially flat surface configured to hold one or more items (e.g., remote controls, laptops, tablets, mobile phones, flyers, beverages, and/or the like). Cover 112 may be configured to couple to the second end of suitcase body 102. Cover 112 may be configure on top of the suitcase or mounted on a separate support structure to create a stable, horizontal surface. This surface can be used to hold items such as remote controls, laptops, tablets, mobile phones, flyers, and beverages, among other things. This additional functionality enhances the overall usability of the transportable display system 100 and makes it more versatile for users. In some implementations, the cover 112 may also include additional features, such as built-in cup holders, slots for holding electronic devices, or compartments for storing small items. These features further contribute to the convenience and practicality of using the cover 112 as a tabletop in various settings.

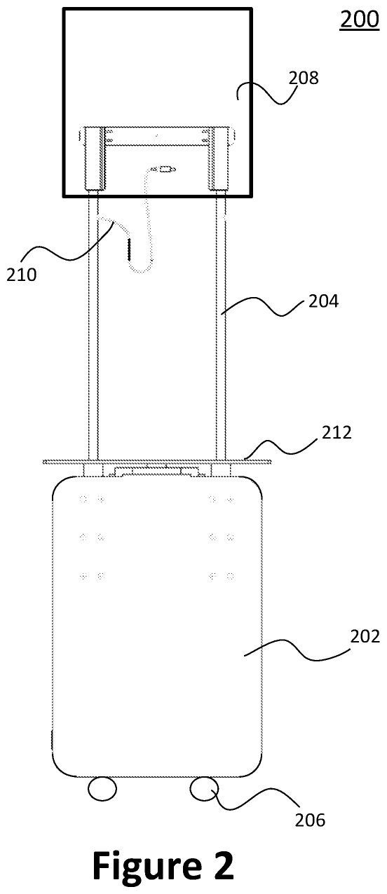

FIG. 2 is a front view of a transportable display system 200 according to embodiments of the present invention. This diagram is merely an example, which should not unduly limit the scope of the claims. One of ordinary skill in the art would recognize many variations, alternatives, and modifications. In various embodiments, transportable display system 200 may include a suitcase body 202, a wheel 206, a support member 204, a power cord 210, and a cover 212, which may be the same as or equivalent to the components described with respect to FIG. 1 and will not be described in detail herein.

As shown, transportable display system 200 may further include a display 208 configured to detachably couple to the suitcase. For example, display 208 can be coupled to the suitcase via support member 204. Display 208 may be configured to display a media file linked to a non-fungible token (NFT) stored on a blockchain. NFT refers to unique digital assets that represent ownership or proof of authenticity for various types of media files through one or more references. NFTs may be created and stored on blockchain networks (e.g., Ethereum), which provide a decentralized and secure way of verifying the ownership and provenance of digital assets. An NFT may be characterized by a unique identifier (e.g., a string of characters), which is stored on the blockchain along with the NFT's metadata and is used to distinguish the NFT from others for authenticity verification. The media file may be linked to the NFT via one or more links and is stored separately from the NFT (e.g., at a different network location). The media file may include, without limitation, a sound clip, a picture, a video clip, and/or the like.

In an exemplary implementation, display 208 may establish a connection with a network entity, such as a blockchain node or a server hosting the NFT data, through a communication interface. The display 208 sends a unique identifier associated with the NFT to the connected network entity for authentication. This unique identifier is stored on the blockchain, along with the NFT's metadata, and is used to verify the authenticity and ownership of the digital asset. Once the authentication process is complete, the display 208 receives the media file linked to the NFT via one or more links. These media files are stored separately from the NFT, often at a different network location or in decentralized file storage systems like IPFS (InterPlanetary File System). The display 208 stores the received media file in its internal memory, ensuring that the file is readily available for playback. The display 208 initiates the playback of the media file, which may include sound clips, pictures, video clips, or other digital media formats. In some implementations, the display 208 features a touchscreen or other user interface that allows users to interact with the NFT-linked media files, control playback, or access additional information related to the NFT. By integrating NFT display functionality into the transportable display system 200, users can securely showcase their digital assets in various settings. This provides an opportunity for NFT owners to display their unique digital art, collectibles, or other media files with the added assurance of authenticity and provenance provided by blockchain technology. Additionally, the transportable display system 200 enables NFT users to engage with the digital art community by sharing and exhibiting their NFT-linked media files in a more interactive and accessible manner.

Depending on the implementations, display 208 can be configured to connect to a mobile device via a communication interface. The communication interface may receive the media file from a network in response to an authorization message. The received media file can be used for display purposes (e.g., via transportable display system 200), allowing authorized user/owner of digital assets to showcase their digital arts and creations in various scenarios (e.g., galleries, exhibitions, personal collections, and/or the like). According to some embodiments, display 208 may be configured to display the media file at a 1:1 scale for optimized visual representation. In some cases, display 208 comprises one or more display screens including, without limitation, one or more liquid crystal displays, one or more light-emitting diode displays, one or more organic light-emitting diode displays, one or more cathode ray tube displays, one or more plasma displays, and/or the like. In some instances, display 208 includes a touch screen for enhanced user interaction.

Display 208 may be characterized by one or more specifications that enhance the overall visual experience and versatility of the transportable display system. For example, display 208 may be characterized by a resolution greater than 1920×1080 (e.g., 4K, 8K, etc), which enables high-quality image reproduction. Display 208 may be characterized by a contrast ratio greater than 1000:1, providing a clear distinction between different color intensities. Display 208 may be characterized by a brightness greater than 300 cd/m², ensuring adequate visibility under various lighting conditions.

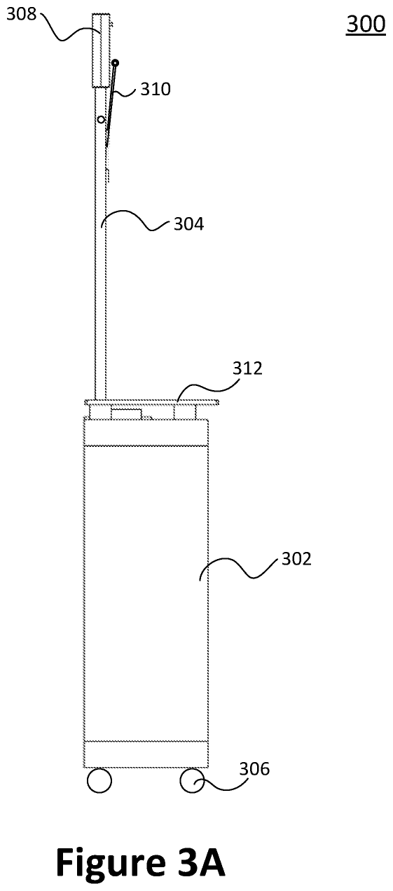

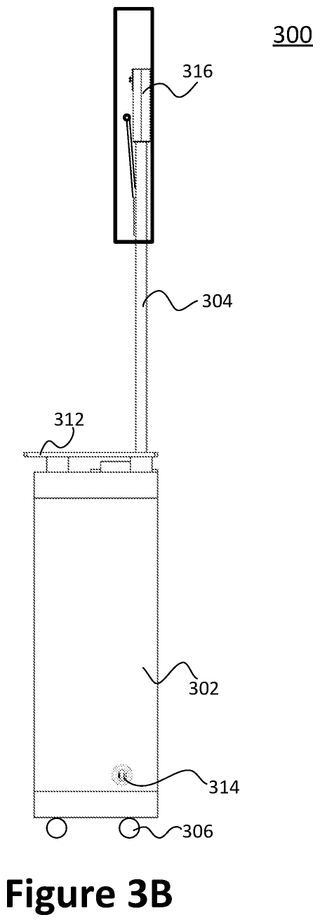

FIGS. 3A-3B are side views of a transportable display system 300 according to embodiments of the present invention. These diagrams are merely examples, which should not unduly limit the scope of the claims. One of ordinary skill in the art would recognize many variations, alternatives, and modifications. In various embodiments, transportable display system 300 may include a suitcase body 302, a wheel 306, a support member 304, a handle 308, a power cord 310, a cover 312, and a display 316, which may be the same as or equivalent to the components described with respect to FIG. 1 and/or FIG. 2 and will not be described in detail herein.

Depending on the implementations, transportable display system 300 may be configured in various modes. For example, transportable display system 100 can be configured in a first mode where suitcase body 102 is configured to accommodate other components (e.g., support member 304, cover 312, display 316, and/or other accessories) for efficient storage of transportation. In some cases, suitcase body 302 further includes a foam member (not shown) configured to protect the components contained therein (e.g., support member 304, cover 312, display 316, and/or the like). The foam member may be positioned within suitcase body 302 and include, without limitation, polyurethane (PU) foam, Polyethylene (PE) foam, Anti-Static foam, Semi-vel foam, Ethylene-vinyl acetate (EVA) foam, and/or the like. By configuring transportable display system 300 in the first mode, users can effortlessly transport the system to various locations. In some cases, the dimensions of the suitcase can meet carry-on luggage size requirements for air travel.

In various implementations, transportable display system 300 can be configured in a second mode and function as a versatile and adaptable presentation platform for various scenarios, such as presentations, exhibitions, or NFT displays. In the second mode, components (e.g., support member 304, cover 312, display 316, and/or other accessories) contained within suitcase body 302 may be extracted from suitcase body 302 and be assembled to form a presentation platform.

Depending on the implementations, transportable display system 300 features various connection mechanisms that allow for secure and efficient attachment of the components, ensuring a reliable and user-friendly assembly process. For example, support member 304 can be detachably coupled to the suitcase body 302 via a locking mechanism, a telescopic extension mechanism, a secure fastening mechanism, and/or the like, allowing support member 304 to be firmly attached to the suitcase and provide structural support for other components (e.g., display 316 or other accessories). In some embodiments, display 316 is configured to detachably couple to the suitcase body 302 via the support member 304. For instance, display 316 may be coupled to support member 304 via one or more structural components (e.g., brackets, hooks, clamps, and/or the like). In an example, display 316 may be coupled to support member 304 via magnetic mounting, which allows for quick and simple assembly and disassembly. Support member 304 includes a magnetic mounting plate and display 316 includes a magnetic element configured on its rear side. By aligning the magnetic mounting plate and the magnetic element, display 316 can be easily fixed to support member 304 through magnetic attraction.

In some embodiments, cover 312 is configured to detachably couple to the suitcase body 302. For example, cover 312 may be coupled to the second end of suitcase body 302 via one or more structural components (e.g., brackets, clamps, magnetic attachments, and/or the like). In some cases, cover 312 may be configured to couple to the support member 304 (e.g., via clips, hooks, slide-in rails, and/or the like). By coupling cover 312 to suitcase body 302 and/or support member 304, cover 312 can function as a front shelf and be easily adjusted or removed as needed.

As shown in FIG. 3B, transportable display system 300 further includes a power module 314 coupled to suitcase body 302. Power module 314 may be configured to provide electrical power for display 316. For example, power cord 310 may be configured to connect display 316 to power module 314. Power cord 310 may be configured inside support member 304 to maintain a visually clean and organized appearance.

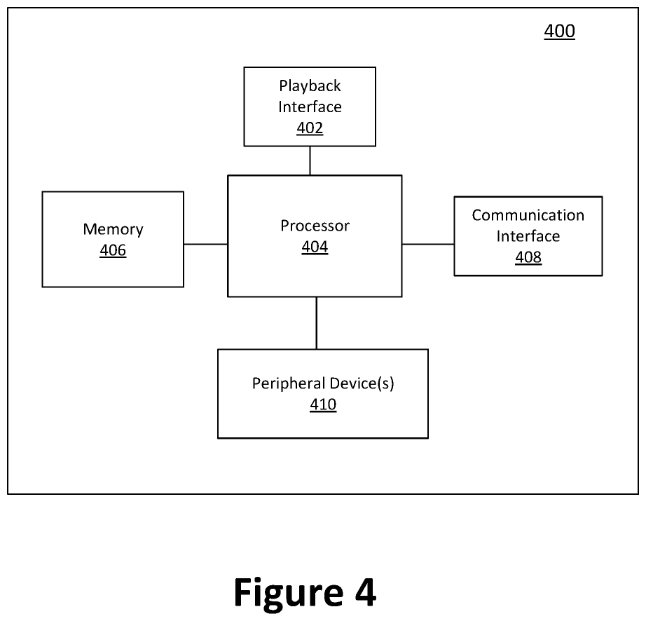

FIG. 4 is a simplified block diagram illustrating a display 400 of a transportable display system according to embodiments of the present invention. This diagram is merely an example, which should not unduly limit the scope of the claims. One of ordinary skill in the art would recognize many variations, alternatives, and modifications.

As shown, display 400 includes a playback interface 402, a processor 404, a memory 406, a communication interface 408, and peripheral device(s) 410, which work collectively to facilitate the acquisition, storage, and playback of a media file linked to an NFT stored on a blockchain. For example, playback interface 402 is configured to provide playback of the media file, enabling users to view or interact with the digital asset associated with the NFT. The media file comprises a sound clip, a picture, and/or a video clip. Playback interface 402 may be compatible with various media formats including, without limitation, images, videos, audio, interactive content, and/or the like. Playback interface 402 may also include controls for pausing, fast-forwarding, rewinding, or adjusting the volume, brightness, and other settings related to the playback of the media file.

In various embodiments, communication interface 408 is configured to establish a connection to a first network entity. For example, the first network entity may include, without limitation, a server, a blockchain, a database storing the NFT metadata, and/or the like. Communication interface 408 may support various communication protocols and standards, such as Wi-Fi, Bluetooth, Ethernet, and/or other wired or wireless connections. In some cases, communication interface 408 is further configured to connect the display to a mobile device (e.g., using Wi-Fi, Bluetooth, near-field communication, cellular communications, and/or other wired or wireless connections), providing a seamless interaction between users and display 400.

In various implementations, processor 404 is coupled to and configured to communicate among other components (e.g., playback interface 402, memory 406, communication interface 408, and/or peripheral device(s) 410). In an example, processor 404 is configured to transmit a unique identifier to the first network entity via the communication interface. The unique identifier may be associated with the NFT and configured to distinguish the NFT from others for authenticity verification. For instance, the unique identifier may include an NFT token ID or wallet address and can be used to request access to the media file associated with the NFT from the first network entity (e.g., a server, a blockchain, a database storing the NFT metadata, and/or the like). Processor 404 may be further configured to receive an authorization message from the first network entity for displaying the media file. For instance, upon receiving the unique identifier, the first network entity verifies the user's ownership or access rights to the media file. If the user is authorized, the first network entity sends an authorization message to processor 404, granting permission to display the media file.

In various implementations, processor 404 may include one or more processing units, such as a central processing unit (CPU), a graphics processing unit (GPU), a neural processing unit (NPU), or any combination thereof. Processor 404 can be configured to implement necessary software and algorithms to generate, interpret, and manage artificial intelligence (AI)-generated content for display. In some cases, processor 404 may further include hardware accelerators for AI workloads, such as tensor processing units (TPUs), neural network processors (NNPs), or specialized GPU cores optimized for machine learning tasks. The software and algorithms implemented by processor 404 may include, without limitation, generative adversarial networks (GANs), deep learning algorithms, reinforcement learning models, and/or other AI techniques. These algorithms enable the creation of various types of AI-generated content, such as artwork, animations, music, or interactive applications, depending on the specific implementation.

The NPU comprises numerous nerve cells and synapses that simultaneously transmit and receive signals to and from each other, allowing it to efficiently process and generate AI content. The NPU can generate various types of media content using AI, which may subsequently be stored in memory 406 and displayed by playback interface 402. For example, the NPU can be used to run generative adversarial networks (GANs) or other image generation algorithms to create original images or modify existing ones for display. In some cases, the NPU can be employed to run speech synthesis algorithms to generate human-like speech or music generation algorithms to create original music compositions. The NPU can also be used to run video generation algorithms to create original video content or modify existing videos for display.

In some embodiments, processor 404 may further optimize the AI-generated content for display on playback interface 402, taking into consideration factors such as resolution, color depth, and aspect ratio. This optimization ensures that the displayed content maintains a high visual quality, providing an engaging and immersive user experience.

Communication interface 408 may be configured for various uses. For example, communication interface 408 may enable the display system to send and receive unique identifiers associated with NFTs to and from network entities. This allows the display system to authenticate the ownership and provenance of the NFT-linked media files, ensuring that the displayed content is genuine and authorized. With a reliable communication interfaces, the display system can receive real-time updates about NFT ownership changes or new NFT creations. This enables users to stay informed about the current status of their NFT collections and potentially discover new digital assets. Additionally, the availability of various communication interface 408 allows users to remotely access and control the display system, enabling them to manage their NFT collections, update settings, or showcase their digital assets from a distance.

Communication interface 408 may be implemented in various ways. A Bluetooth implementation enables short-range wireless communication between display 400 and other devices, such as mobile phones or tablets. This interface can be used for transferring small amounts of data, control signals, or for pairing with user devices for seamless interaction. A wired communication interface (e.g., ethernet) provides a reliable, high-speed connection between display 400 and local area networks, servers, blockchains, or databases. Ethernet is particularly suitable for situations where a stable connection is crucial. With a cellular communication interface, display 400 can connect to the internet or other networks via mobile data. This enables the display to operate in locations without Wi-Fi or Ethernet access, providing greater flexibility and mobility. USB or other wired interfaces: Display 400 can also use USB or other wired communication interfaces to connect with devices, servers, or databases. These interfaces provide a stable and secure connection for data transfer and communication. A satellite network interface can be used to connect system 400 to the internet or other networks via satellite communication. This enables connectivity in remote locations without access to traditional network infrastructure.

Depending on the implementations, processor 404 is configured to receive the media file over the communication interface 408. The media file may be stored separately from the NFT. For example, communication interface 408 can establish a connection to a second network entity and receive the media file from the second network entity in response to the authorization message. Once the media file is received, processor 404 may be configured to direct memory 406 to store the media file locally, enabling the display system to access and playback the media file without requiring a continuous connection to the network entity. Memory 406 may be configured to store the media file and can include, without limitation, a random-access memory (RAM) device, an image buffer device, or the like. In some cases, processor 404 is further configured to instruct playback interface 402 to start playback of the media file. Playback interface 402 provides an optimized visual representation of the media file, allowing users to view or interact with the digital content associated with the NFT.

NFT and other data stored at memory 406 may be highly valuable. To secure memory 406, the stored media files can be encrypted using strong encryption algorithms such as AES (Advanced Encryption Standard) or other industry-standard encryption methods. Processor 404 can manage the encryption and decryption of media files, ensuring that only authorized users or devices can access the content. Additionally, the encryption keys can be stored securely using hardware security modules (HSMs) or secure key storage techniques. Implementing access control mechanisms can help ensure that only authorized users or devices can access the stored media files. Access control can be based on user authentication, such as passwords, biometrics, or digital certificates. Furthermore, processor 404 can manage permissions for accessing memory 406, allowing only authorized operations like read, write, or delete. A secure boot process can be employed to ensure that the display system and its components, including memory 406, are running trusted and secure firmware or software. This can help prevent unauthorized tampering or modification of the system, protecting the integrity of the stored media files. In some embodiments, memory 406 may be configured to be tamper-resistant, incorporating physical and electronic security measures to prevent unauthorized access, modification, or removal of the stored data. This can include techniques such as potting, shielding, or secure chip designs that detect and respond to tampering attempts. Ensuring that the display system's firmware and software are updated securely can help maintain the overall security of memory 406. Secure update mechanisms can include digital signatures, secure communication channels, and rollback protection to prevent unauthorized updates or modifications.

In various embodiments, system 400 further includes one or more peripheral device(s) 410 configured to improve user interaction in various aspects. For example, peripheral device(s) 410 may include, without limitation, at least one of the speaker(s) or earpiece(s), audio sensor(s) or microphone(s), noise sensors, keyboard, mouse, and/or other input/output devices.

Other embodiments of this system include corresponding computer systems, apparatus, and computer programs recorded on one or more computer storage devices, each configured to perform the actions of the methods.

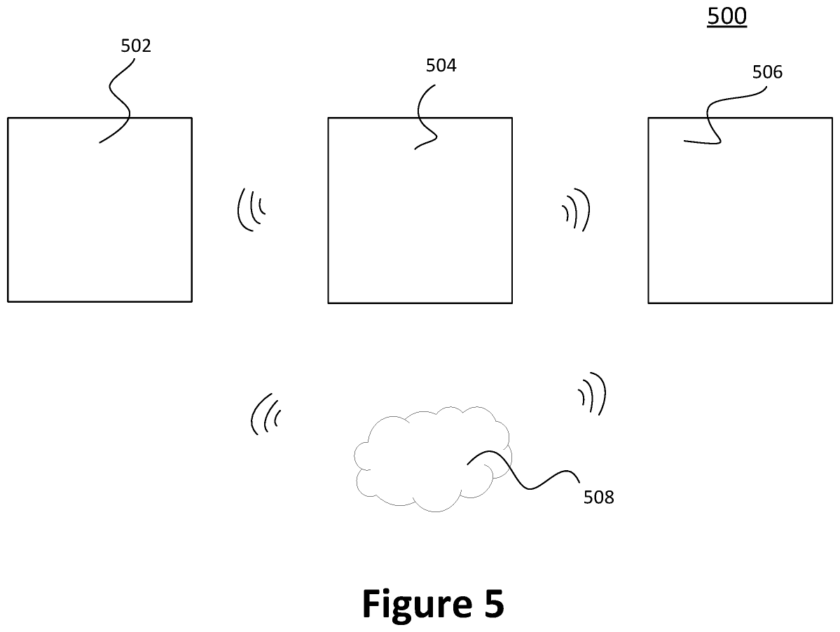

FIG. 5 is a simplified block diagram illustrating a multi-display system 500 of a transportable display system according to embodiments of the present invention. This diagram is merely an example, which should not unduly limit the scope of the claims. One of ordinary skill in the art would recognize many variations, alternatives, and modifications.

Depending on the implementation, a transportable display system (e.g., transportable displays of FIGS. 1-3) may include a multi-display system 500, which includes a plurality of displays configured for displaying a media file. The plurality of display can be wireless connected and syschoronized to provide an immersive and engaging experience for users. For example, as shown in FIG. 5, multi-display system 500 include a first display 502, a second display 504, and a third display 506, which can be wireless interconnected via a wireless network 508. The wireless connection allows for seamless communication among the displays, as well as easy setup and reconfiguration without the need for physical wiring.

In various implementations, a synchronization controller 510 manages the synchronization of the displays, ensuring that the content displayed on each screen is coordinated and aligned. The controller 510 can be a software application or a dedicated device that communicates with each display via the wireless network 508. To avoid latencies and disruptions, a synchronization controller may be used. The synchronization controller refers to a type of software or application that can run on various devices and is responsible for coordinating the activities among the devices (e.g., first display 502, second display 504, third display 506, etc.). The synchronization controller is configured to manage the wireless connections, tracks the status of each display, and sends synchronization signals as necessary to ensure that all displays present their content in a synchronized manner.

Multi-display System 500 provides a cohesive and interactive multi-display experience, enhancing the user's engagement with the media content (e.g., digital art, AI-generated content, and/or the like). It offers a versatile and adaptable solution for various media consumption scenarios, including entertainment, educational, professional, advertisement, and more.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A display system, comprising:
a suitcase comprising a suitcase body and a wheel coupled to a first end of the suitcase body;
a support member configured to detachably couple to the suitcase; and
a display configured to detachably couple to the suitcase via the support member, the display being further configured to display a media file, the media file being linked to a non-fungible token (NFT) stored on a blockchain;
wherein the suitcase body is configured to accommodate the support member and the display, the suitcase body further comprises a foam member configured to protect the support member and the display.

2. The display system of claim 1, further comprising a cover configured to detachably couple to a second end of the suitcase body, the suitcase body being configured to accommodate the cover.

3. The display system of claim 1, wherein the wheel comprises a locking mechanism configured to control the wheel movement.

4. The display system of claim 1, wherein the suitcase further comprises a power module coupled to the suitcase body, the power module is configured to provide electrical power for the display.

5. The display system of claim 4 wherein the support member further comprises a power cord configured to connect the display to the power module.

6. The display system of claim 5 wherein the power cord is configured inside the support member.

7. The display system of claim 1, wherein the media file comprises a sound clip, a picture, and/or a video clip.

8. The display system of claim 1, wherein the display comprises a touch screen.

9. The display system of claim 1, wherein the display further comprises:
a playback interface configured to provide playback of the media file;
a communication interface configured to establish a connection to a first network entity;
a memory configured to store the media file;
a processor configured to:
transmit a unique identifier to the first network entity via the communication interface;
receive an authorization message from the first network entity for displaying the media file;
receive the media file over the communication interface;
store the media file in the memory; and
starting playback of the media file.

10. The display system of claim 9 wherein the display is configured to connect to a mobile device via the communication interface.

11. The display system of claim 1 wherein a height of the support member is adjustable.

12. A display system, comprising:
a suitcase comprising a suitcase body and a wheel coupled to a first end of the suitcase body;
a support member configured to detachably couple to the suitcase; and
a display configured to detachably couple to the suitcase via the support member, the display being further configured to display a media file, the display further comprising:
a playback interface configured to provide playback of the media file;
a communication interface configured to establish a connection to a first network entity;
a processor configured to receive the media file over the communication interface in response to an authorization message for displaying the media file from the first network entity, the media file being linked to a non-fungible token (NFT) on a blockchain; and
a memory configured to store the media file;
wherein the suitcase body is configured to accommodate the support member and the display.

13. The display system of claim 12, wherein the communication interface is further configured to connect the display to a mobile device.

14. The display system of claim 12, wherein the display is configured to display the media file at a 1:1 scale.

15. The display system of claim 12, further comprising a cover configured to couple to the support member.

16. The display system of claim 12, wherein the display is characterized by a resolution greater than 1920×1080.

17. A display system, comprising:
a suitcase comprising a suitcase body, a wheel coupled to a first end of the suitcase body, and a handle coupled to a second end of the suitcase body;
a support member configured to detachably couple to the suitcase; and
a display configured to detachably couple to the suitcase via the support member, the display being further configured to display a media file, the media file being linked to a non-fungible token (NFT) associated with an authorized owner, an identification of the authorized owner being stored on a blockchain;
wherein the suitcase body is configured to accommodate the support member and the display.

18. The display system of claim 17, wherein the suitcase body further comprises a foam member positioned inside the suitcase body.

19. The display system of claim 17, further comprising a cover configured to detachably couple to the second end of the suitcase body, the suitcase body being configured to accommodate the cover.

20. The display system of claim 1, wherein the media file comprises a sound clip, a picture, and/or a video clip.
